(19) United States
(12) Patent Application Publication
(10) Pub. No.: US 2012/0047340 A1
(43) Pub. Date: Feb. 23, 2012

(54) INFORMATION PROCESSING APPARATUS, METHOD OF CONTROLLING INFORMATION PROCESSING APPARATUS, AND PROGRAM

(75) Inventor: Keishi Inaba, Yokohama-shi (JP)

(73) Assignee: CANON KABUSHIKI KAISHA, Tokyo (JP)

(21) Appl. No.: 13/206,351

(22) Filed: Aug. 9, 2011

(30) Foreign Application Priority Data
Aug. 20, 2010 (JP) 2010-184783

(51) Int. Cl. G06F 12/16

(52) U.S. Cl. 711/162; 711/E12.103

(57) ABSTRACT

An apparatus includes a plurality of storage units, a setting unit configured to set mirroring areas to be subjected to mirroring in storage areas of the plurality of storage units, a determination unit configured to determine a degree of importance of data to be stored in the storage units, and a control unit configured to perform control to store data that has a high degree of importance into the mirroring areas of the plurality of storage units, and store data that has a low degree of importance into a non-mirroring area of any one of the storage units.

### BACKGROUND OF THE INVENTION

1. Field of the Invention

The present invention relates to an information processing apparatus, a method for controlling an information processing apparatus, and a program.

2. Description of the Related Art

An image forming apparatus having a copying function and a printer function includes a storage device inside. Programs of the apparatus, program processing data, and user data are stored in the storage device. Some image forming apparatuses include a plurality of storage devices and perform mirroring to protect data stored in the storage devices and perform data backup processing.

In regard to providing a plurality of storage devices, protecting data stored in such storage devices, and performing data backup processing, Japanese Patent Application Laid-Open No. 2002-175157 discusses an apparatus in which storage devices, or storages, can be replaced for extending a storage capacity.

The foregoing conventional technology mainly uses hard disk drives (HDDs) as the storage devices.

In recent years, solid state drives (SSDs) have appeared as storage devices. An HDD and an HDD have conventionally been combined to perform mirroring to protect data in the storage devices of the image forming apparatus. Aside from such a conventional combination, a new combination of an HDD and an SSD, a storage device of different type, has become possible.

Since SSDs are costly, an image forming apparatus system becomes very expensive if an SSD having the same storage capacity as that of an HDD is used. Therefore, in terms of cost, the capacity of the SSD for use is reduced. As compared to HDDs, SSDs are capable of high-speed read operation.

Thus, using an HDD and an SSD in combination and performing a read operation with the SSD can speed up the performance of the image forming apparatus. A mechanism effective for mirroring with a combination of a plurality of storage devices of different types and capacities has thus been desired.

### SUMMARY OF THE INVENTION

According to an aspect of the present invention, an apparatus includes a plurality of storage units, a setting unit configured to set mirroring areas to be subjected to mirroring in storage areas of the plurality of storage units, a determination unit configured to determine a degree of importance of data to be stored in the storage units, and a control unit configured to perform control to store data that has a high degree of importance into the mirroring areas of the plurality of storage units, and store data that has a low degree of importance into a non-mirroring area of anyone of the storage units.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a hardware configuration of an image forming apparatus to which an information processing apparatus according to an exemplary embodiment of the present invention is applicable.

FIG. 2 illustrates control of a storage unit in a conventional image forming apparatus.

FIG. 3 illustrates control of the storage unit in the image forming apparatus according to the present invention.

FIGS. 4A and 4B illustrate a storage method of the storage unit in the image forming apparatus according to the present invention.

FIG. 5 illustrates mirroring setting in the image forming apparatus according to the present invention.

FIG. 6 illustrates the mirroring setting in the image forming apparatus according to the present invention.

FIG. 7 is a flowchart illustrating mirroring processing on image data when the image forming apparatus according to the present invention executes a scan job.

FIG. 8 is a flowchart illustrating data storage processing when the image forming apparatus according to the present invention executes a job.

FIG. 9 illustrates mirroring setting of a second exemplary embodiment.

FIG. 10 illustrates the mirroring setting of the second exemplary embodiment.

FIGS. 11A and 11B illustrate another storage method of the storage unit in the image forming apparatus according to the present invention.

FIGS. 12A and 12B illustrate another storage method of the storage unit in the image forming apparatus according to the present invention.

FIGS. 13A and 13B illustrate another storage method of the storage unit in the image forming apparatus according to the present invention.

### DESCRIPTION OF THE EMBODIMENTS

Various exemplary embodiments, features, and aspects of the invention will be described in detail below with reference to the drawings.

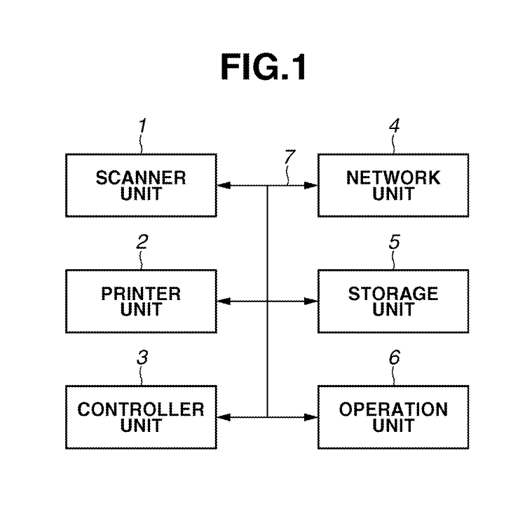

FIG. 1 is a block diagram illustrating a hardware configuration of an image forming apparatus to which an information processing apparatus according to an exemplary embodiment of the present invention is applicable.

In FIG. 1, an image forming apparatus 10 is an exemplary embodiment of the information processing apparatus according to the present invention. In the image forming apparatus 10, a scanner unit 1 reads a document to generate image data. A printer unit 2 prints data generated by the image forming apparatus 10 onto a print medium. A controller unit 3 performs data processing including the processing of the image data read by the scanner unit 1 and that of the data to be printed by the printer unit 2. The controller unit 3 also performs control on the image forming apparatus 10. The controller unit 3 includes a central processing unit (CPU), a read-only memory (ROM), and a random access memory (RAM). The CPU executes computer-readable programs recorded in the ROM to implement various types of controls.

A network unit 4 performs control on data transmission and reception to/from external devices such as a personal computer (PC) over a not-illustrated network. A storage unit 5 includes storages (storage devices) such as a hard disk drive (HDD) and a solid state drive (SSD) and uses the storages to store various types of data, including image data read by the scanner unit 1 and print data.

An operation unit 6 controls a not-illustrated operation panel to display various types of information and input user instructions. A bus 7 is a system bus through which control signals from the controller unit 3 and data signals between the devices are transmitted and received.

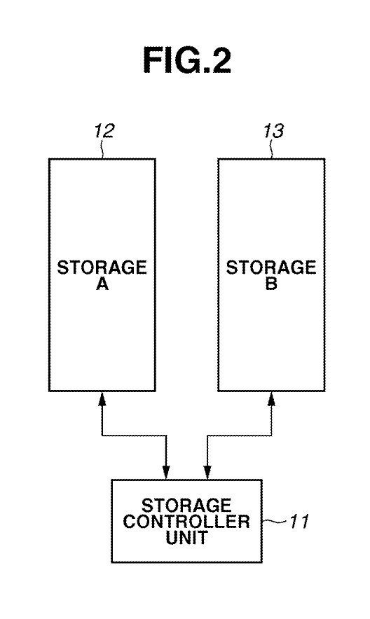

Referring to FIG. 2, the control of a storage unit in a conventional image forming apparatus will be described. FIG. 2 illustrates the control of the storage unit in the conventional image forming apparatus.

As illustrated in FIG. 2, the storage unit of the conventional image forming apparatus includes a storage controller unit 11, a storage A 12, and a storage B 13. The storage controller unit 11 communicates with the controller unit 3, and transmits and receives data to/from the storage A 12 and/or the storage B 13. The storage A 12 and the storage B 13 include respective HDDs with the same storage capacity.

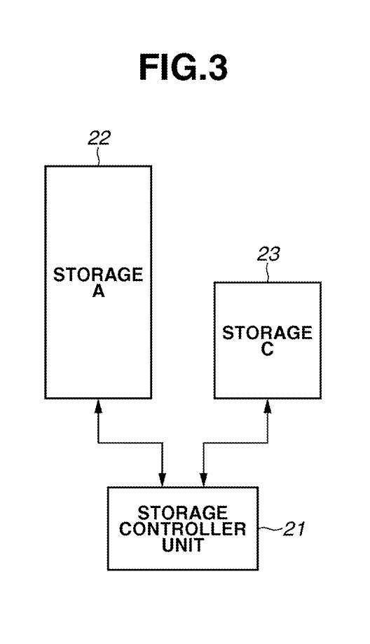

Referring to FIG. 3, the control of the storage unit in the image forming apparatus according to the exemplary embodiment of the present invention will be described below. FIG. 3 illustrates the control of the storage unit in the image forming apparatus according to the exemplary embodiment of the present invention.

As illustrated in FIG. 3, the storage unit 5 of the image forming apparatus 10 according to the present invention includes a storage controller unit 21, a storage A 22, and a storage C 23. The storage controller unit 21 communicates with the controller unit 3, transmits data to the storage A 22 and/or the storage C 23, and receives data from the storage A 22 and/or the storage C 23. In other words, the storage controller unit 21 performs data storage control on the storage A 22 and the storage C 23. The storage A 22 includes an HDD. The storage C 23 includes an SSD. The storage C 23 has a storage capacity smaller than that of the storage A 22.

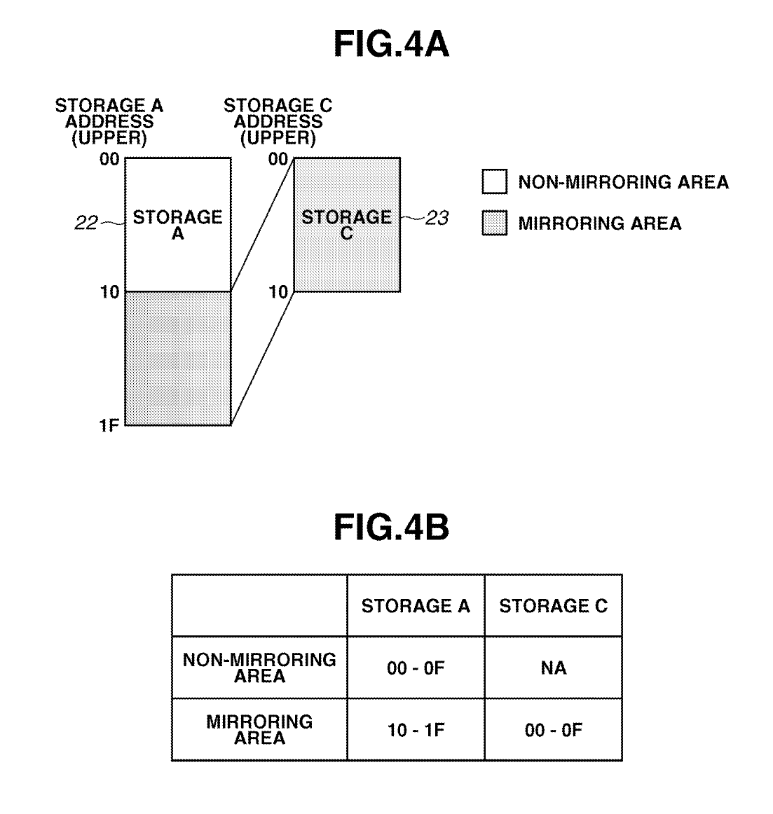

FIGS. 4A and 4B illustrate a storage method of the storage unit in the image forming apparatus according to the present invention. In particular, FIG. 4A corresponds to a diagram that illustrates storage areas of the storage A 22 and the storage C 23 in FIG. 3. Referring to FIGS. 4A and 4B, a method of mirroring of the image forming apparatus according to the present invention will be described below.

The following is the method by which the image forming apparatus stores data into the storages. The storages used in the image forming apparatus include an HDD and an SSD. Examples of the data to be stored into such storages include program data of the image forming apparatus, apparatus setting data (setting data on the image forming apparatus), user-stored data (data stored in response to a storage instruction from the user), image data, and image processing intermediate data. The image forming apparatus stores all pieces of such data in the storage unit 5, which uses an enormous amount of the storage capacity.

In view of this, the image forming apparatus adds a degree of importance to the data to be stored into the storages. The program data, the apparatus setting data, and the user-stored data have a high degree of importance. The controller unit 3 adds data degree of importance information of “1” to header information on such pieces of data.

Buffer data, temporary data, and intermediate data during data processing (image processing) of the image forming apparatus have a low degree of importance. The controller unit 3 adds data degree of importance information of “0” to header information on such pieces of data.

The data having a low degree of importance refers to temporary data that is temporarily stored in the storage unit 5 in the process of data processing. The data having a high degree of importance refers to data other than the temporary data. The pieces of data stored in the storages of the image forming apparatus are classified into the two groups (data having the high degree of importance and data having the low degree of importance).

The image forming apparatus maybe configured so that the user can set the data types of the data having the high degree of importance from a degree of importance setting screen on the operation unit 6 (not illustrated).

For example, the image forming apparatus 10 may include a facsimile unit and be capable of transmitting and receiving facsimile data. In such a case, the user may specify the received facsimile data to be data having the high degree of importance or data having the low degree of importance from the operation unit 6. The image forming apparatus 10 may have a web browser function. In such a case, the user may specify a user-input password, included in temporary files stored by the web browser function, to be data having the high degree of importance or data having the low degree of importance.

The above descriptions are just a few examples, and the data of which the user can specify the degree of importance is not limited thereto. It should be noted that even the temporary data described above is handled by the controller unit 3 as the data having the high degree of importance if so specified by the user in the case that the user specifies the degree of importance. On the other hand, even the data other than the above-described temporary data is handled by the controller unit 3 as having the low degree of importance if so specified by the user.

Next, storage address conversion will be described. In the following description, all addresses will be expressed in hexadecimal notation.

The storage A 22 and the storage C 23 illustrated in FIG. 4A have different storage capacities, which precludes a simple mirroring operation. The reason is that the difference in capacity makes a mirroring operation over the entire space of the storage A 22 and the storage C 23 impossible. To perform a mirroring operation between storages of different capacities as in FIG. 4A, storage address conversion is used.

The storage controller unit 21 of the image forming apparatus contains an address correspondence list (address correspondence information) for the storage A and the storage C as illustrated in FIG. 4B.

For example, in the case of the storages in FIG. 4A, addresses “00” to “0F” of the storage A are set to have no corresponding address of the storage C (non-mirroring area). Addresses “10” to “1F” of the storage A are set to correspond to addresses “00” to “0F” of the storage C (mirroring area).

The mirroring operation between the storage A 22 and the storage C 23 in FIG. 4A will be described below.

The storage A 22 includes an HDD with address space of “00” to “1F.” The storage C 23 includes an SSD with address space of “00” to “0F.”

The address space “00” to “0F” of the storage A 22 is set to be a non-mirroring area, and the address space “10” to “1F” (hatched area) is set to be a mirroring area. The address space “00” to “0F” (hatched area) of the storage C 23 is set to be a mirroring area. The storage controller unit 21 sets the mirroring area and the non-mirroring area in the address spaces as specified from the operation unit 6. The address correspondence list in FIG. 4B is stored in a nonvolatile memory in the storage controller unit 21.

The storage controller unit 21 determines that an address space is a mirroring area if the address space has a corresponding address in the address correspondence list (for example, FIG. 4B). The storage controller unit 21 determines that an address space is a non-mirroring area if the address space has no corresponding address in the address correspondence list.

If the nonvolatile memory in the storage controller unit 21 contains the address correspondence list as illustrated in FIG. 4B and the address correspondence list matches the storage configuration, the storage controller unit 21 determines that mirroring setting is performed. On the other hand, if there is no address correspondence list or if the address correspondence list does not match the storage configuration (for example, when the storages are replaced), the storage controller unit 21 determines that mirroring setting is not performed.

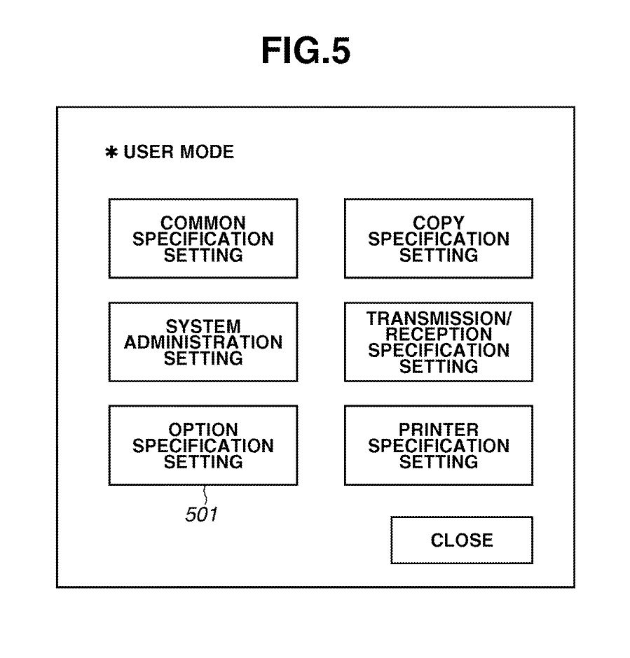

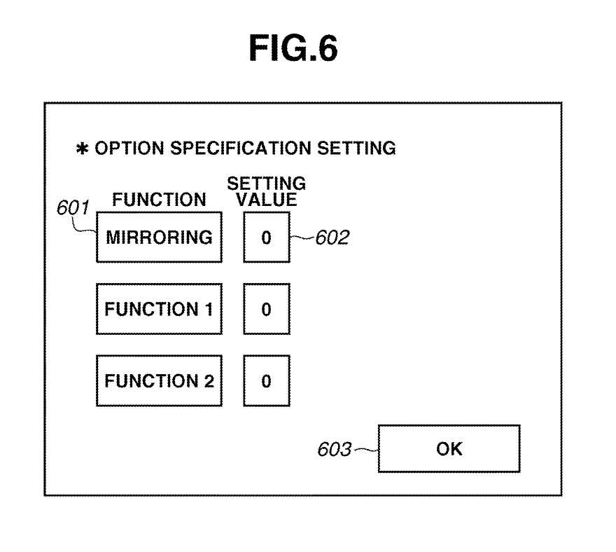

Referring to FIGS. 5 and 6, the mirroring setting of the image forming apparatus according to the present invention will be described below. FIGS. 5 and 6 illustrate the mirroring setting of the image forming apparatus according to the present invention. Initially, when the user presses a user mode key (not illustrated) on the operation unit 6, the controller unit 3 performs control to display a user mode screen illustrated in FIG. 5 on a display unit (equipped with a touch panel) of the operation unit 6.

When the user presses an option specification setting button 501 on the user mode screen of FIG. 5, the controller unit 3 controls screen transition to display an option specification setting screen illustrated in FIG. 6 on the display unit of the operation unit 6.

When the user presses (touches) a mirroring button 601 on the option specification setting screen of FIG. 6, the controller unit 3 performs control to accept input to a setting value 602 of the mirroring setting from a numeric keypad (not illustrated) of the operation unit 6. The setting value 602 of the mirroring setting is “0” by default, which is a state that the mirroring setting is not performed. When the user inputs “1” (mirroring setting) to the setting value 602 from the numeric keypad and presses an OK button 603, the controller unit 3 notifies the storage controller unit 21 of the activation of the mirroring setting.

The storage controller unit 21 notified creates an address correspondence list as illustrated in FIG. 4B, and stores the address correspondence list into the nonvolatile memory in the storage controller unit 21. The storage controller unit 21 subsequently performs mirroring control based on the address correspondence list.

When the user inputs “0” (no mirroring setting) to the setting value 602 of the mirroring setting again and presses the OK button 603, the controller unit 3 notifies the storage controller unit 21 of the release of the mirroring setting. The storage controller unit 21 notified performs control to delete the address correspondence list (FIG. 4B) stored in the nonvolatile memory of the storage controller unit 21 and release the mirroring setting.

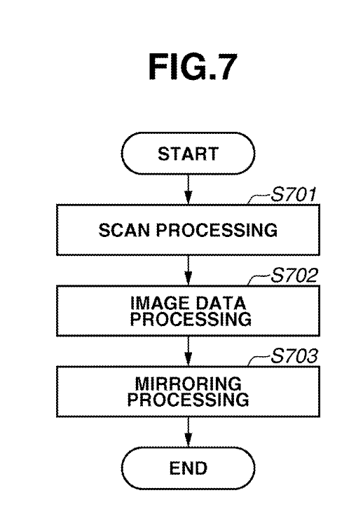

Referring to a flowchart in FIG. 7, mirroring processing on image data for the case of executing a scan job with the storage configuration of FIGS. 4A and 4B will be briefly described.

FIG. 7 is a flowchart illustrating the mirroring processing on image data when the image forming apparatus according to the present invention executes a scan job. The processing in steps S701 and S702 in the flowchart is implemented by the CPU of the controller unit 3 reading and executing a program that is recorded in the ROM or the like of the controller unit 3 in a computer-readable fashion.

The processing in step S703 in the flowchart is implemented by a CPU of the storage controller unit 21 reading and executing a program that is recorded in a ROM or the like of the storage controller unit 21 in a computer-readable fashion. The following description will be given on the assumption that the mirroring setting illustrated in FIG. 6 has been performed.

When the user sets a document to be scanned on a platen of the scanner unit 1 of the image forming apparatus according to the present invention and inputs a scan operation from the operation unit 6, the controller unit 3 starts the processing in the flowchart. In step S701, the controller unit 3 initially controls the scanner unit 1 to perform scan processing. The scanner unit 1 reads a document image from the document, converts the document image into image data, and transmits the image data to the controller unit 3.

In step S702, the controller unit 3 processes the image data transmitted from the scanner unit 1, and transmits the processed image data to the storage unit 5.

In step S703, the storage unit 5 receives the image data transmitted from the controller unit 3. The storage controller unit 21 checks the degree of importance of the image data, and performs mirroring processing to write the image data to a storage 22 and a storage 23. Then, the processing in the flowchart is ended. As described above, the mirroring processing is performed on image data.

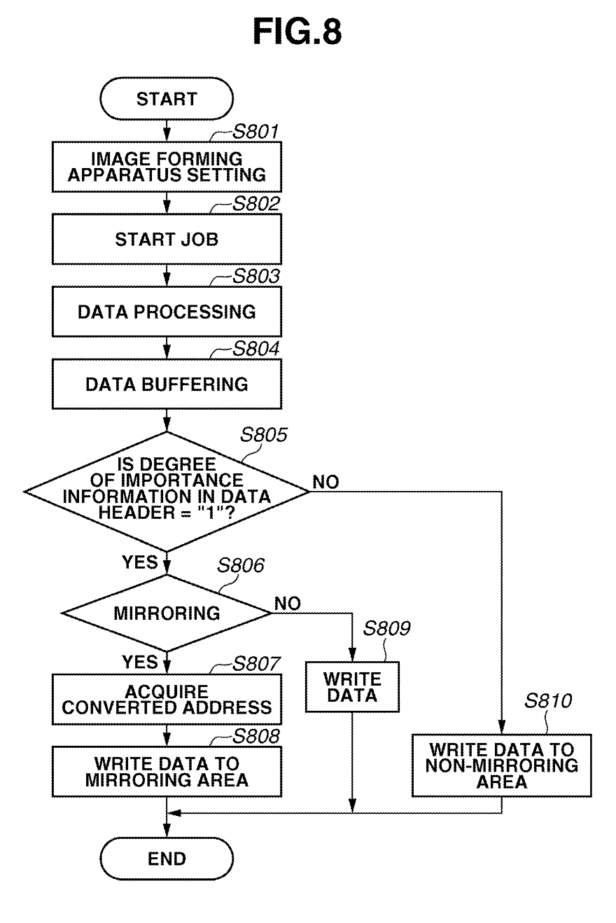

FIG. 8 is a flowchart illustrating data storage processing when the image forming apparatus according to the present invention executes a job. The processing insteps S801 to S804 in the flowchart is implemented by the CPU of the controller unit 3 reading and executing a program that is recorded in the ROM or the like of the controller unit 3 in a computer-readable fashion.

The processing in steps S805 to S810 in the flowchart is implemented by the CPU of the storage controller unit 21 reading and executing a program that is recorded in the ROM or the like of the storage controller unit 21 in a computer-readable fashion.

In step S801, when the user inputs an instruction to start setting the image forming apparatus from the operation unit 6, the controller unit 3 receives image forming apparatus setting (address conversion setting for implementing the mirroring function of the storage) from the operation unit 6. After the image forming apparatus setting, the controller unit 3 performs control to receive a job. If no particular setting is performed, the processing simply proceeds to step S802, in which case the job operation is performed using default values as illustrated in FIGS. 4A and 4B.

The storage controller unit 21 of the storage unit 5 may notify the controller unit 3 of the detection of a change in the storage configuration of the storage unit 5. In such a case, the controller unit 3 performs control to receive the image forming apparatus setting from the operation unit 6. The image forming apparatus setting is transmitted from the controller unit 3 to the storage controller unit 21 of the storage unit 5, and stored into a memory in the storage controller unit 21.

In step S802, the controller unit 3 receives an instruction to start a job, and starts the job. For example, in the case of a scan job as illustrated in FIG. 7, the controller unit 3 reads a document image from the scanner unit 1 of the image forming apparatus.

In step S803, the controller unit 3 performs data processing on the read image data. Here, the controller unit 3 adds information that indicates the degree of importance of the data (degree of importance information) to the header information on the image data. The controller unit 3 gives the degree of importance of “0” to temporary data, and the degree of importance of “1” to important data.

In step S804, the controller unit 3 temporarily stores the data processed in step S803 into a data buffer that is provided in a memory in the controller unit 3. The data stored in the data buffer is successively transmitted by the controller unit 3 to the storage unit 5.

In step S805, the storage controller unit 21 of the storage unit 5 receives the data transmitted from the controller unit 3 and determines whether the degree of importance information in the data header of the data is “1” (data having the high degree of importance).

If the degree of importance information in the data header is “1,” i.e., the data is determined to have the high degree of importance (Yes in step S805), the processing proceeds to step S806. In step S806, the storage controller unit 21 determines whether the storage unit 5 is set as capable of mirroring (mirroring setting is performed).

If the mirroring setting is performed (Yes in step S806), then in step S807, the storage controller unit 21 acquires converted addresses for the mirroring function (address correspondence list) that are stored in the memory in the storage controller unit 21.

It is determined in step S805 that the degree of importance information in the data header is “1,” i.e. , the data is important data. In step S808, the storage controller unit 21 then writes the data determined as the important data to the mirroring areas (in the example in FIG. 4B, both “10-1F” of the storage A and “00-0F” of the storage C) according to the address correspondence list acquired in step S807.

Completing writing to the mirroring areas of the storages, the storage controller unit 21 notifies the controller unit 3 of the completion of the data writing. Thus, the mirroring write processing is ended.

On the other hand, if the storage unit 5 is determined not to be set for mirroring (No in step S806), then in step S809, the storage controller unit 21 writes the data to either one of the storages (for example, the storage A).

Completing writing to the storage, the storage controller unit 21 notifies the controller unit 3 of the completion of the data writing. Thus, the write processing in the case of no mirroring setting is ended.

If the degree of importance information in the data header is “0,” i.e., the data is determined to be temporary data (No in step S805), then in step S810, the storage controller unit 21 simply writes the data to the non-mirroring area of the storage (in the example in FIG. 4B, “00-0F” of the storage A).

Completing writing to the storage, the storage controller unit 21 notifies the controller unit 3 of the completion of the data writing. Thus, the write processing on the temporary data is ended.

If the storage controller unit 21 determines that the data header does not contain the degree of importance information (No in step S805), then in step S810, the storage controller unit 21 simply writes the data to the non-mirroring area of the storage (in the example in FIG. 4B, “00-0F” of the storage A).

As described above, the image forming apparatus according to the present exemplary embodiment allows replacement of storage devices with ones of different types and different capacities, with a configuration change for reduced capacity. Further, the image forming apparatus can also use the entire space of the storage devices. Further, the storage controller unit 21 can perform a read operation of the mirroring function with the SSD (for example, the storage C in FIGS. 4A and 4B), thus a high-speed reading can be realized. Accordingly, the performance of the image forming apparatus 10 can be improved and thus user usability can also be improved.

Consequently, it is possible to implement mirroring control with a combination of a plurality of storage devices of different capacities (and types). It is also possible to use the entire space of the plurality of storage devices and improve the processing performance and user usability.

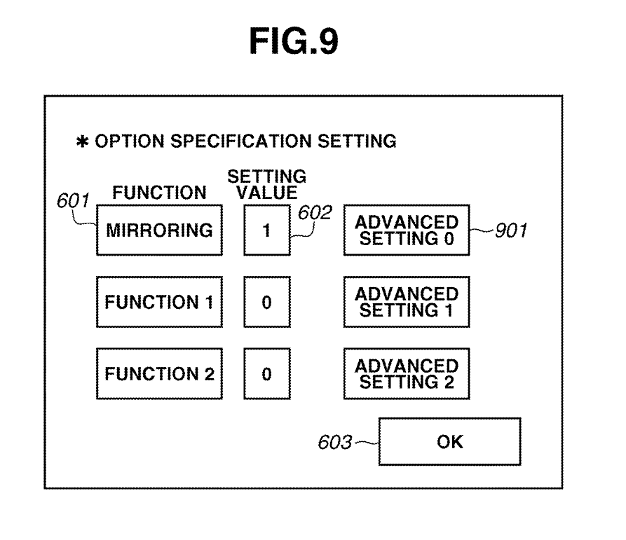

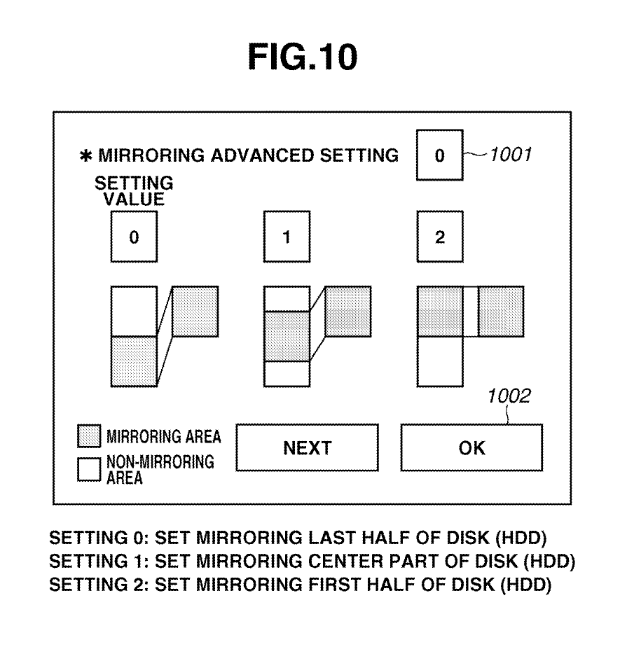

A second exemplary embodiment is configured so that the mirroring areas can be selected and specified by a user operation. Referring to FIGS. 9 and 10, the mirroring setting according to the second exemplary embodiment of the present invention will be described below. FIGS. 9 and 10 illustrate the mirroring setting according to the second exemplary embodiment of the present invention.

In the second exemplary embodiment, when the user presses the option specification setting button 501 on the user mode screen illustrated in FIG. 5, the controller unit 3 controls screen transition to display an option specification setting screen illustrated in FIG. 9 on the display unit of the operation unit 6.

When the user presses (touches) an advanced setting button 901 on the option specification setting screen in FIG. 9, the controller unit 3 controls screen transition to display a mirroring advanced setting screen illustrated in FIG. 10 on the display unit of the operation unit 6.

The controller unit 3 then performs control to receive an input to a setting value 1001 of the mirroring advanced setting from the numeric keypad (not illustrated) of the operation unit 6. The setting value 1001 of the mirroring advanced setting is “0” by default. Such mirroring setting is targeted for the last half of the disk as illustrated in FIGS. 4A and 4B.

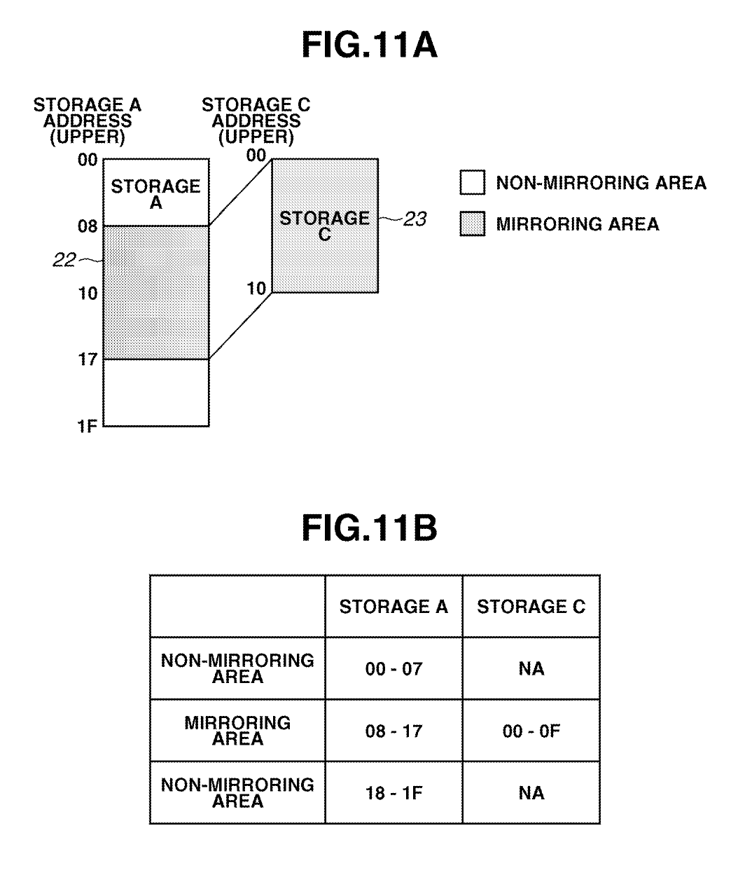

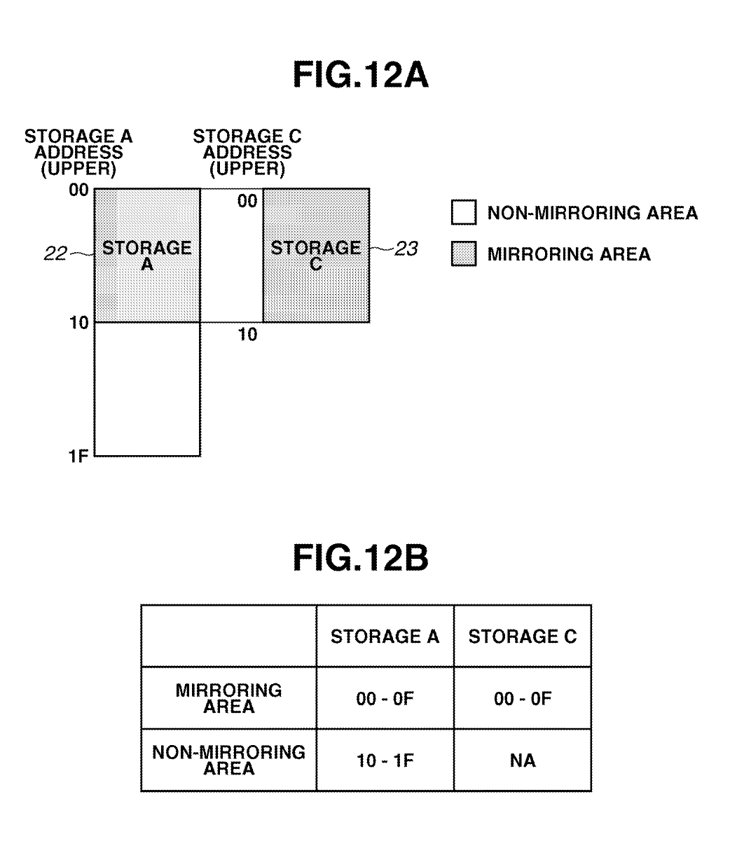

When the user inputs “1” to the setting value 1001 of the mirroring advanced setting from the numeric keypad, the mirroring setting is targeted for a center part of the disk as illustrated in FIGS. 11A and 11B. When the user inputs “2” to the setting value 1001 of the mirroring advanced setting from the numeric keypad, the mirroring setting is targeted for the first half of the disk as illustrated in FIGS. 12A and 12B.

When the user presses the OK button 603 with “1” in the setting value 602, the controller unit 3 notifies the storage controller unit 21 of the mirroring setting and the setting value 1001 of the mirroring advanced setting. The storage controller unit 21 notified creates an address correspondence list corresponding to the setting value 1001 of the mirroring advanced setting, and stores the address correspondence list into the nonvolatile memory in the storage controller unit 21. The storage controller unit 21 subsequently performs mirroring control on the storages based on the address correspondence list.

The image forming apparatus maybe configured so that when the user selects setting 1 (to set mirroring the center part of the disk) on the mirroring advanced setting screen in FIG. 10, the user can further specify the start address of the mirroring area from the operation unit 6.

Now, other storage methods of the storage unit (settings for mirroring the center part of the disk and mirroring the first half of the disk) in the image forming apparatus according to the present invention will be described with reference to FIGS. 11A, 11B, 12A, and 12B.

FIGS. 11A and 11B illustrate another storage method of the storage unit (a setting for mirroring the center part of the disk) in the image forming apparatus according to the present invention. In particular, FIG. 11A corresponds to a diagram that illustrates the storage areas of the storage A 22 and the storage C 23 in FIG. 3. Referring to FIGS. 11A and 11B, the setting for mirroring the center part of the disk will be described below. FIGS. 11A and 11B differ from FIGS. 4A and 4B in the mirroring area and the non-mirroring area of the storage A.

In FIG. 11A, the storage A used in the image forming apparatus is an HDD with a storage address space of “00” to “1F.” The “00” side of the address space corresponds to the outer periphery side of the HDD. The “1F” side of the address space corresponds to the inner periphery side of the HDD. The HDDs can make both read and write operations at higher speed on the outer periphery side than on the inner periphery side. In other words, the access time to the outer periphery side of the HDD is shorter than to the inner periphery side. The mirroring area and the non-mirroring area of the storage A 22 can thus be modified in setting to improve the processing performance of the image forming apparatus.

In the example of setting illustrated in FIGS. 11A and 11B where the center part of the disk is subjected to mirroring, addresses “08” to “17” of the storage A are set to correspond to “00” to “0F” of the storage C.

As illustrated in FIG. 11B, the mirroring area and the non-mirroring area of the storage A are set as follows. Addresses “00” to “07” of the storage A have no corresponding address of the storage C. Addresses “08” to “17” of the storage A correspond to “00” to “0F” of the storage C. Addresses “18” to “1F” of the storage A have no corresponding address of the storage C.

In the storage A, the address space “00” to “07” is set to be the non-mirroring area, the address space “08” to “17” (hatched area) is set to be the mirroring area, and the address space “18” to “1F” is set to be the non-mirroring area. The address space “00” to “0F” (hatched area) of the storage C is set to be the mirroring area.

With the storage set in FIGS. 11A and 11B, mirroring processing on the storage A and the storage C is performed similar to that in FIG. 8. Temporary data with the degree of importance of “0”, which is distinguished by the data header, is written to the address space “00” to “07” of the storage A. Important data corresponding to the degree of importance of “1” is written to both “08” to “17” of the storage A and “00” to “0F” of the storage C, and subjected to the mirroring processing.

In the storage A that is set as in FIGS. 11A and 11B, both temporary data with the degree of importance “0” and important data with the degree of importance “1” are processed in areas closer to the outer periphery of the HDD. This improves the processing performance of the image forming apparatus as compared to the default case (FIGS. 4A and 4B).

FIGS. 12A and 12B illustrate another storage method of the storage unit (a setting for mirroring of the first half of the disk) in the image forming apparatus according to the present invention. In particular, FIG. 12A corresponds to a diagram that illustrates the storage areas of the storage A 22 and the storage C 23 in FIG. 3. Referring to FIGS. 12A and 12B, the setting for mirroring of the first half of the disk will be described below. FIG. 12A differs from FIG. 4A in the mirroring area and the non-mirroring area of the storage A.

In the example of setting illustrated in FIGS. 12A and 12B where the first half of the disk is subjected to mirroring, addresses “00-0F” of the storage A are set to correspond to “00-0F” of the storage C. The following is the setting of the mirroring area and the non-mirroring area of the storage A 22.

As illustrated in FIG. 12B, addresses “00” to “0F” of the storage A correspond to “00” to “0F” of the storage C (mirroring area), and addresses “10” to “1F” of the storage A have no corresponding address of the storage C (non-mirroring area).

In other words, the address space “00” to “0F” (hatched area) of the storage A is set to be the mirroring area, and the address space “10” to “1F” is set to be the non-mirroring area. The address space “00” to “0F” (hatched area) of the storage C is set to be the mirroring area.

With the storage settings in FIGS. 12A and 12B, mirroring processing on the storage A and the storage C is similarly performed to that in FIG. 8. The degree of importance of data is distinguished by the data header. Temporary data corresponding to the degree of importance of “0” is written to the address space “10” to “1F” of the storage A. Important data corresponding to the degree of importance of “1” is written to both “00” to “0F” of the storage A and “00” to “0F” of the storage C for mirroring processing.

According to the present exemplary embodiment, as illustrated in FIGS. 11A and 11B, the data storage areas of the storage devices can be finely set so as to perform mirroring on the center part of the disk (HDD). Consequently, data storage processing is performed in areas closer to the outer periphery of the HDD. Such configuration makes it possible to write to high-speed areas of the HDD by an HDD write operation. This, the image forming apparatus according to the present exemplary embodiment can improve in processing performance, which allows improved user usability.

A third exemplary embodiment is configured so that the mirroring area and the non-mirroring area can be more finely specified by a user operation.

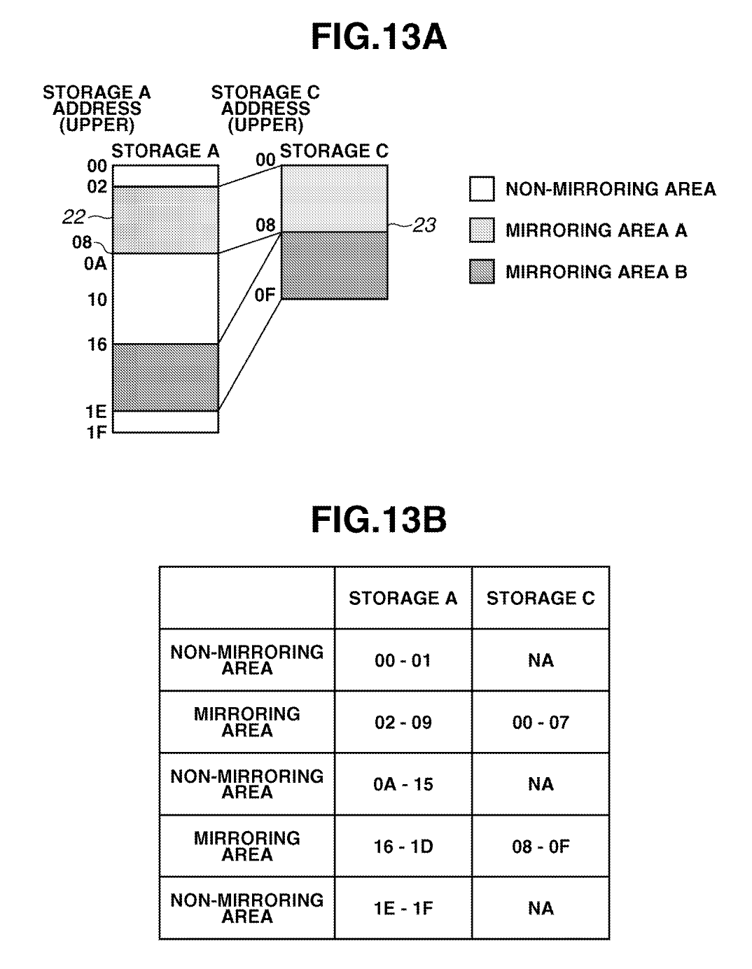

FIGS. 13A and 13B illustrate another storage method of the storage unit in the image forming apparatus according to the present invention. In particular, FIG. 13A corresponds to a diagram that illustrates the storage areas of the storage A 22 and the storage C 23 in FIG. 3. Referring to FIGS. 13A and 13B, the mirroring of the third exemplary embodiment will be described below. FIGS. 13A and 13B differ from FIGS. 11A and 11B in that the mirroring area and the non-mirroring area can be set more finely.

When the user presses (touches) the advanced setting button 901 on the option specification setting screen of FIG. 9, the controller unit 3 controls screen transition to display a mirroring advanced setting screen (not illustrated) on the display unit of the operation unit 6. The controller unit 3 displays a diagram of storages and address spaces like illustrated in FIGS. 4A and 4B on the mirroring advanced setting screen, and receives settings for partitioning the area of the storage C 23 from the operation unit 6. For example, as illustrated in FIGS. 13A and 13B, “00” to “07” of the storage C may be set to be a mirroring area A, and “08” to “0F” is set to be a mirroring area B.

Next, the controller unit 3 receives corresponding address settings for the storage A. For example, as illustrated in FIGS. 13A and 13B, “00” to “07” of the storage C may be set to correspond to “02” to “09” of the storage A, and “08” to “0F” of the storage C may be set to correspond to “16” to “1D” of the storage A. When the user fixes such settings (presses an OK button), the controller unit 3 notifies the storage controller unit 21 of the information about the mirroring setting.

The storage controller unit 21 notified creates an address correspondence list corresponding to the information about the mirroring setting (for example, FIG. 13B), and stores the address correspondence list into the nonvolatile memory in the storage controller unit 21. The storage controller unit 21 subsequently performs mirroring control based on the address correspondence list.

The following is the setting of the mirroring area and the non-mirroring area of the storage A in FIGS. 13A and 13B.

As illustrated in FIG. 13B, addresses “00” and “01” of the storage A have no corresponding address of the storage C (non-mirroring area). Addresses “02” to “09” of the storage A correspond to addresses “00” to “07” of the storage C (mirroring area). Addresses “0A” to “15” of the storage A have no corresponding address of the storage C 23 (non-mirroring area).

Addresses “16” to “1D” of the storage A correspond to addresses “08” to “0F” of the storage C (mirroring area). Addresses “1E” and “1F” of the storage A have no corresponding address of the storage C (non-mirroring area).

In other words, the address spaces “02” to “09” and “16” to “1D” (hatched areas) of the storage A are set to be the mirroring areas, and the address spaces “00” to “01,” “0A” to “15,” and “1E” to “1F” are set to be the non-mirroring areas. The address space “00” to “0F” (hatched area) of the storage C is set to be the mirroring area.

With the storage settings in FIGS. 13A and 13B, mirroring processing on the storage A and the storage C is similarly performed to that in FIG. 8. The degree of importance of data is distinguished by the data header. Temporary data corresponding to the degree of importance of “0” is written to the address space “00” to “01,” “0A” to “15,” or “1E” to “1F” of the storage A. Important data corresponding to the degree of importance of “1” is written to both “02” to “09” or “16” to “1D” of the storage A and “00” to “0F” of the storage C for mirroring processing.

In the storage A that is set as in FIGS. 13A and 13B, both temporary data with the degree of importance “0” and important data with the degree of importance “1” are processed in areas closer to the outer periphery of the HDD. This improves the processing performance of the image forming apparatus as compared to the cases of FIGS. 4A, 4B, 11A, 11B, 12A, and 12B.

According to the present exemplary embodiment, as in FIGS. 13A and 13B, the data storage areas of the storage devices can be set more finely. Consequently, data storage processing on both the mirroring area and the non-mirroring area can be performed in areas closer to the outer periphery of the HDD. Such configuration makes it possible to write both important data and temporary data to high-speed areas of the HDD by an HDD write operation. Thus, the image forming apparatus according to the present exemplary embodiment can improve in processing performance, which allows improved user usability.

In the configuration illustrated in FIGS. 13A and 13B, two discrete storage areas of the storage 22 can be specified from the operation unit 6 as the storage areas of the storage 22 to mirror the entire storage area of the storage 23 with small capacity. However, the number of discrete storage areas of the storage 22 that can be specified as mirroring areas is not limited to two. The image forming apparatus may be configured so that three or more discrete storage areas can be specified from the operation unit 6.

The above-described exemplary embodiments have dealt with an apparatus that is configured to perform mirroring with two storage devices. However, the present invention is also applicable to an apparatus that is configured to perform mirroring with a plurality of more than two storage devices (which may differ in storage capacity and in type). In such a case, the user specifies from the operation unit 6 the storage areas of storages to mirror the entire storage area of the storage that has the smallest storage capacity. Based on the specification, the storage controller unit 21 sets the mirroring areas in the storage areas of the plurality of storages.

In the configuration corresponding to the first exemplary embodiment, the storage areas of the other storages to mirror the entire storage area of the storage having the smallest storage capacity among the plurality of storages are set to where the access time is longer (the outer periphery sides of the HDDs). Data stored in the mirroring areas is read from a storage of the type that has the shortest read time.

For example, when the image forming apparatus includes a plurality of HDDs and an SSD, the data is read from the SSD. When the image forming apparatus includes a plurality of HDDs and a plurality of SSDs, the data is read from an SSD that has the shortest read time. The storage controller unit 21 may measure the data read time by actually reading data from each storage, and determine the storage to read data from based on the measurement.

In the configuration corresponding to the second exemplary embodiment, the user specifies the storage areas of the other storages to mirror the entire storage area of the storage having the smallest storage capacity. The controller unit 3 accepts the specification from the operation unit 6 (screens as illustrated in FIGS. 9 and 10). The storage controller unit 21 sets the storage areas of the other storages that are specified to be the mirroring areas, as the storage areas to mirror the entire storage area of the storage having the smallest storage capacity.

In the configuration corresponding to the third exemplary embodiment, the controller unit 3 performs control so that the user can specify a plurality of discrete storage areas of the other storages from the operation unit 6 as the storage areas of the other storages to mirror the entire storage area of the storage having the smallest storage capacity.

In the above-described exemplary embodiments, the image forming apparatus is described as an example of the information processing apparatus according to the present invention. However, the information processing apparatus according to an exemplary embodiment of the present invention may also cover apparatuses other than an image forming apparatus, such as a personal computer (PC) and a server computer (server).

For example, in the case of a PC or server, data having a low degree of importance may include temporary files that are stored by a web browser, temporary program work files that are stored during installation or use of a program, and data that is saved to a virtual memory. The temporary files stored by a web browser may include Internet temporary files such as data that is stored for quick display (copies of web pages, images, and media), cookies, a browsing history, form data, and passwords.

The data saved to a virtual memory refers to data that is temporarily saved to a secondary storage device because of insufficient physical memory capacity. In other words, the virtual memory is set to be a non-mirroring area. In the case of a PC or server, data other than the data having a low degree of importance described above is data having a high degree of importance.

As described above, the application of the information processing apparatus according to the present invention to a PC or server can improve the processing performance of the PC or server for improved user usability. The information processing apparatus can thus implement mirroring control with a combination of a plurality of storage devices of different capacities (and different types). It is also possible to use the entire space of the plurality of storage devices, and improve the processing performance and user usability.

While exemplary embodiments of the present invention have been described above, the present invention may be practiced, for example, as a system, apparatus, method, program, storage medium, and other modes of embodiment. More specifically, the present invention may be applied to a system that includes a plurality of devices. The present invention may be applied to an apparatus that includes a single device. All combinations of the configurations of the above-described exemplary embodiments are intended to be covered by the present invention.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-184783 filed Aug. 20, 2010, which is hereby incorporated by reference herein in its entirety.

What is claimed is:

1. An apparatus comprising:
a plurality of storage units;
a setting unit configured to set mirroring areas to be subjected to mirroring in storage areas of the plurality of storage units;
a determination unit configured to determine a degree of importance of data to be stored in the storage units; and
a control unit configured to perform control to store data that has a high degree of importance into the mirroring areas of the plurality of storage units, and store data that has a low degree of importance into a non-mirroring area of any one of the storage units.

2. The apparatus according to claim 1, wherein the plurality of storage units include storage units having different storage capacities, and
wherein the setting unit sets an entire storage area of a storage unit having a smallest storage capacity among the plurality of storage units as a mirroring area.

3. The apparatus according to claim 2, wherein the setting unit sets a storage area of another storage unit to mirror the entire storage area of the storage unit having the smallest storage capacity to a storage area where access time is longer in the entire storage area of the another storage unit.

4. The apparatus according to claim 2, further comprising a specification unit configured to receive specification of a storage area of another storage unit to mirror the entire storage area of the storage unit having the smallest storage capacity,
wherein the setting unit sets the storage area of the another storage unit specified by the specification unit as a storage area to mirror the entire storage area of the storage unit having the smallest storage capacity.

5. The apparatus according to claim 4, wherein the specification unit specifies a plurality of discrete storage areas of the another storage unit as the storage area of the another storage unit to mirror the entire storage area of the storage unit having the smallest storage capacity.

6. The apparatus according to claim 2, wherein the setting unit generates address correspondence information about the mirroring areas of the plurality of storage units, and
wherein the control unit performs mirroring control on the plurality of storage units using the generated address correspondence information.

7. The apparatus according to claim 1, wherein the plurality of storage units includes storage units of different types, and
wherein the control unit reads data from a storage unit of a type that has a shortest read time if the data stored in the mirroring areas of the storage units is read.

8. The apparatus according to claim 1, wherein the determination unit determines that the data has a low degree of importance if the data is temporary data to be temporarily stored in the storage units during processing, and determines that the data has a high degree of importance if the data is not the temporary data.

9. The apparatus according to claim 8, wherein the data that is not the temporary data is program data or setting data of the apparatus, or data that is stored in response to a storage instruction from a user.

10. The apparatus according to claim 1, further comprising a degree of importance setting unit configured to set a degree of importance for a data type,
wherein the determination unit determines the degree of importance of data based on the set degree of importance.

11. The apparatus according to claim 1, wherein the determination unit adds degree of importance information to the data, and
wherein the control unit performs control to store the data into the mirroring areas or the non-mirroring area based on the added degree of importance information.

12. A method for controlling an apparatus including a plurality of storage units, the method comprising:
setting mirroring areas to be subjected to mirroring in storage areas of the plurality of storage units;
determining a degree of importance of data to be stored in the storage units; and
performing control to store data that has a high degree of importance into the mirroring areas of the plurality of storage units, and to store data that has a low degree of importance into a non-mirroring area of any one of the storage units.

13. The method according to claim 12, wherein the plurality of storage units include storage units having different storage capacities, and
wherein the setting sets an entire storage area of a storage unit having a smallest storage capacity among the plurality of storage units as a mirroring area.

14. The method according to claim 12, further comprising receiving specification of a storage area of another storage unit to mirror the entire storage area of the storage unit having the smallest storage capacity,
wherein the setting sets the storage area of the another storage unit specified as a storage area to mirror the entire storage area of the storage unit having the smallest storage capacity.

15. The method according to claim 12, further comprising:
generating address correspondence information about the mirroring areas of the plurality of storage units; and
performing mirroring control on the plurality of storage units using the generated address correspondence information.

16. The method according to claim 12, further comprising setting a degree of importance for a data type,
wherein the determining determines the degree of importance of data based on the set degree of importance.

17. A storage medium storing a program causing an apparatus including a plurality of storage units to perform a method according to claim 12.

18. The storage medium according to claim 17, wherein the plurality of storage units include storage units having different storage capacities, and
wherein the setting sets an entire storage area of a storage unit having a smallest storage capacity among the plurality of storage units as a mirroring area.

19. The storage medium according to claim 17, further comprising receiving specification of a storage area of another storage unit to mirror the entire storage area of the storage unit having the smallest storage capacity,
wherein the setting sets the storage area of the another storage unit specified as a storage area to mirror the entire storage area of the storage unit having the smallest storage capacity.

20. The storage medium according to claim 17, further comprising:
generating address correspondence information about the mirroring areas of the plurality of storage units; and
performing mirroring control on the plurality of storage units using the generated address correspondence information.
